(19) United States
(12) Patent Application Publication
(10) Pub. No.: US 2021/0019669 A1
(43) Pub. Date: Jan. 21, 2021

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventors: Kana MIYAZAKI, Kanagawa (JP); Kengo TOKUCHI, Kanagawa (JP)

(73) Assignee: FUJI XEROX CO., LTD., Tokyo (JP)

(21) Appl. No.: 16/740,476

(22) Filed: Jan. 12, 2020

(30) Foreign Application Priority Data
Jul. 17, 2019 (JP) 2019-132301

(51) Int. Cl. G06Q 10/02

(52) U.S. Cl. CPC G06Q 10/02

(57) ABSTRACT

An information processing system includes a reservation information acquiring unit that acquires reservation information that is information on a reservation of a place made by a user; and a setting unit that makes settings concerning output of information in the place reserved by the user on the basis of the reservation information.

### CROSS-REFERENCE TO RELATED APPLICATIONS

This application is based on and claims priority under 35 USC 119 from Japanese Patent Application No. 2019-132301 filed Jul. 17, 2019.

### BACKGROUND

### (i) Technical Field

The present disclosure relates to an information processing system, an information processing apparatus, and a non-transitory computer readable medium.

### (ii) Related Art

Japanese Unexamined Patent Application Publication No. 2014-182027 discloses processing performed by a generating unit. Specifically, the generating unit generates guide information including destination information and information on a positional relationship with a destination on a basis of the destination information and transmits the guide information to a signage terminal.

Japanese Unexamined Patent Application Publication No. 2010-217940 discloses generating a search result screen including an underground route and an aboveground route that are separated at an underground exit on an overlapping map and outputting the search result screen to a signage terminal.

Japanese Unexamined Patent Application Publication No. 2010-079768 discloses comparing acquired shop information with a shop database, generating a shop map on which the matching shop information is placed on map coordinates, and transmitting the shop map to a signage terminal.

Japanese Unexamined Patent Application Publication No. 2013-238959 discloses a usage information registering unit that collects and registers usage information indicative of a state of user's usage of relevant information supplied from a signage terminal to a mobile terminal through a proximity communication means.

Japanese Unexamined Patent Application Publication No. 2016-095837 discloses offering digital signage information to a user who has a user terminal through a display device that has data input and output functions.

Japanese Unexamined Patent Application Publication No. 2010-079770 discloses processing performed by a signage management server. Specifically, the signage management server generates a display screen that reflects operator content usage history information retrieved by using an operator ID and displays the display screen on a signage terminal.

### SUMMARY

In a case where an image or sound is output in a place reserved by a user, the user can be notified of information.

Some of places reserved by users have low sound insulation performance. In such places, it is sometimes desirable to lower sound or stop output of sound. Meanwhile, in such places, voice and noise outside the places are more audible. It is therefore sometimes desirable to increase a volume of sound output in the places. Furthermore, in a case where contents of information to be output vary depending on a user who made a reservation, information can be more effectively transmitted to the user.

Aspects of non-limiting embodiments of the present disclosure relate to controlling output of information so that contents of information to be output in a place reserved by a user vary or a way in which the information is to be output in the place varies.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a reservation information acquiring unit that acquires reservation information that is information on a reservation of a place made by a user; and a setting unit that makes settings concerning output of information in the place reserved by the user on the basis of the reservation information.

### BRIEF DESCRIPTION OF THE DRAWINGS

An exemplary embodiment of the present disclosure will be described in detail based on the following figures, wherein:

FIG. 1 schematically illustrates an overall configuration of an information processing system;

FIG. 2 is a view for explaining an example of a booth-type space;

FIG. 3 is a view for explaining an example of a hardware configuration of a space management server;

FIG. 4 is a diagram illustrating an example of a hardware configuration of a user terminal;

FIG. 5 is a view for explaining an example of a functional configuration of the space management server;

FIG. 6 illustrates an example of a display screen displayed on a user terminal of a reservation applicant when the reservation applicant makes a reservation of a space;

FIG. 7 illustrates another example of a display screen displayed on the user terminal;

FIG. 8 illustrates a reservation list stored in an information storage unit of the space management server;

FIG. 9 illustrates a user list stored in the information storage unit of the space management server;

FIG. 10 illustrates a space list; and

FIG. 11 illustrates an example of flow of processing performed by the space management server.

### DETAILED DESCRIPTION

An exemplary embodiment of the present disclosure is described below with reference to the drawings.

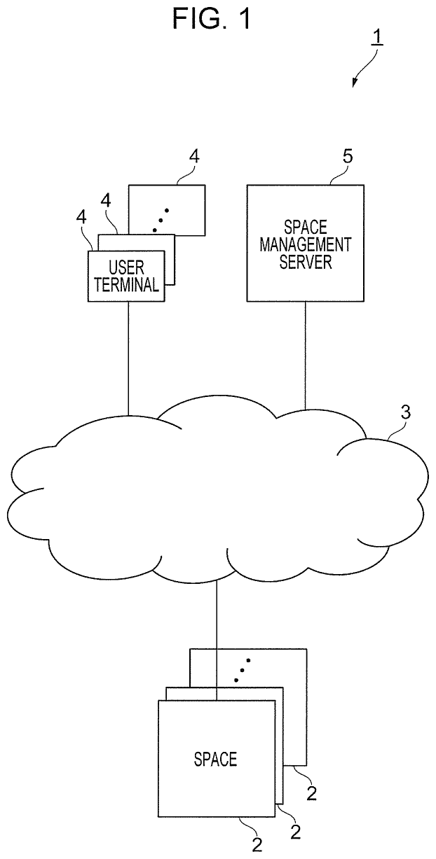

FIG. 1 schematically illustrates an overall configuration of an information processing system 1 according to the present exemplary embodiment.

In the present exemplary embodiment, plural spaces 2, each of which is an example of a place reserved and used by a user, are provided.

Examples of the spaces 2 include booths, guest rooms of a facility such as an accommodation facility, and conference rooms of a company. These are examples of the spaces 2 that are partitioned from surroundings by a wall, a partition, or the like. Furthermore, examples of the spaces 2 according to the present exemplary embodiment include tables and seats on which service is offered at a restaurant, a barber shop, or the like. These are examples of the spaces 2 opened to surroundings.

The information processing system 1 illustrated in FIG. 1 includes various terminals connected to a cloud network 3.

In FIG. 1, user terminals 4 operated by users and a space management server 5 that manages the spaces 2 are illustrated as examples of the terminals connected to the cloud network 3. Furthermore, the spaces 2 are connected to the cloud network 3. More specifically, various apparatuses are provided in the spaces 2, and these apparatuses are connected to the cloud network 3.

The spaces 2 may be managed by a single business operator or plural business operators. For example, different business operators may be in charge of management of reservations, management of entry into and exit from rooms, statuses of usage of rooms, and the like, management of charging of usage fees on users, and management of members registered as users.

As described above, the spaces 2 managed as targets reserved by users need not be spaces of the same type. For example, some of the spaces 2 may be booths, and some of the spaces 2 may be seats or tables of a restaurant or the like.

Furthermore, management of a single purpose or function may be provided by plural business operators in cooperation.

In the present exemplary embodiment, doors of the spaces 2 are equipped with an electronic lock so that the spaces 2 can be locked. In the present exemplary embodiment, persons who have an authority to unlock the spaces 2 can access the spaces 2.

To unlock a space 2, a person who tries to unlock the space 2 gives an unlocking instruction by operating his or her user terminal 4. This instruction is sent to the space management server 5, and the space management server 5 receives the instruction. Then, the space management server 5 gives an instruction to unlock the space 2 for which the unlocking instruction is aimed. This causes the electronic lock of the space 2 to operate, thereby unlocking the space 2.

In the present exemplary embodiment, it is assumed that the user terminals 4 are smartphones, which are portable. Note, however, that the portable user terminals 4 may be wearable terminals, notebook computers, or gaming terminals.

The space management server 5 manages various kinds of information related to the spaces 2. For example, the space management server 5 manages information for specifying users, information for specifying the spaces 2 reserved by users, start dates and times of reservations, and end dates and times of reservations.

Examples of the information for specifying users include users' names, genders, ages, nationalities, accounts, user IDs, passwords, and information for management given to the individuals. Examples of the information for specifying the spaces 2 used by users include information for specifying places such as addresses or locations and names and numbers for management.

The space management server 5 may manage reservations of articles and services associated with the spaces 2. For example, the space management server 5 may manage articles and services that are permitted to be borrowed or used and consumed or consumable articles and services.

Furthermore, the space management server 5 manages various kinds of information related to usage of the spaces 2. For example, the space management server 5 manages information on statuses of usage of the spaces 2 and information on users of the spaces 2.

Furthermore, the space management server 5 unlocks and locks the spaces 2.

### Appearance Configuration of Spaces 2

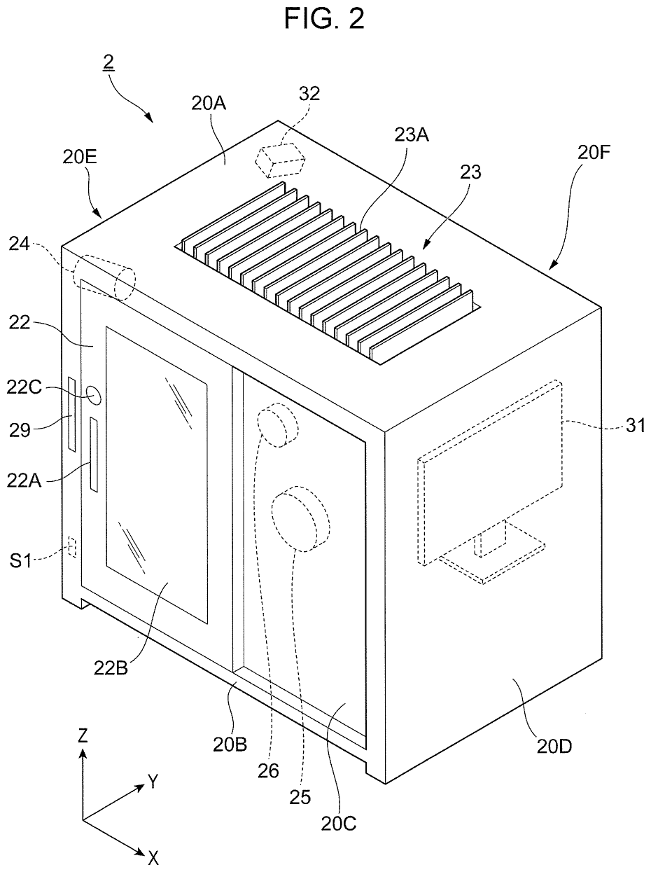

FIG. 2 is a view for explaining an example of a booth-type space 2.

The booth-type space 2 illustrated in FIG. 2 is placed at an indoor or outdoor place such as a train station, an airport, an office building, a commercial facility such as a restaurant or a department store, a bank, a library, an art museum, a museum, a public institution or facility, an accessway, or a park.

The booth-type space 2 illustrated in FIG. 2 is a closed-type booth provided with a ceiling. Note that the closed type does not mean “completely closed” and just needs to have practical sound insulation.

That is, the space 2 may have an opening or a gap such as an air inlet or a small window in a part of a body of the space 2. The window may be openable and closable.

The body of the space 2 illustrated in FIG. 2 includes a ceiling 20A, a floor 20B, a wall 20C equipped with a door 22, which is openable and closable, two walls 20D and 20E located on both sides of the wall 20C, and a wall 20F that faces the door 22.

In FIG. 2, the ceiling 20A has a ventilating hole 23. The ventilating hole 23 is provided with a louver 23A that can adjust an opening area. In FIG. 2, the louver 23A is fully opened.

In the present exemplary embodiment, an inside of the body and an outside of the body are communicated through the ventilating hole 23, and a temperature in the inside of the body and a temperature in the outside of the body are substantially equal accordingly. In particular, in the present exemplary embodiment, no air-conditioning apparatus such as a heating apparatus or a cooling apparatus is provided in the body, and therefore the temperature in the inside of the body and the temperature in the outside of the body are substantially equal.

Note that an air-conditioning apparatus may be provided in the body so that the temperature in the inside of the body can be adjusted.

In the present exemplary embodiment, it is assumed that the door 22 is a sliding door that is movable along the wall 20C. Although the door 22 is a single sliding door that slides in one direction in FIG. 2, the door 22 may be a sliding doorset including two or more members sliding on respective lanes or a sliding doorset including two members sliding on a single lane.

In the present exemplary embodiment, the door 22 is provided with a handle 22A used by a user to open or close the door 22. Furthermore, the door 22 is provided with an electronic lock 22C that can lock and unlock the door 22. Furthermore, in the present exemplary embodiment, the door 22 is provided with an opening closing sensor S1 that detects opening and closing of the door 22.

The number of users which the space 2 accommodates is roughly determined by a volume of the space 2. In the present exemplary embodiment, it is assumed that the space 2 is a cabin-type space that is basically used by a single person.

Note, however, that the space 2 may be a large room that accommodates a large number of persons. The large room may be a single independent room or may be a room created by connecting plural rooms 2 by removing one of or both of the walls 20D and 20E of the spaces 2.

Note that the cabin type does not mean that only one person can use the space and means that a small number of persons (e.g., two or three persons) can use the space.

A shape and a structure of the body, equipment, and performance of the space 2 are not limited in particular. For example, the ceiling 20A may be removed.

In the present exemplary embodiment, a single desk and a single chair (not illustrated) are placed in the body. Furthermore, supplied equipment and apparatuses, reserved equipment and apparatuses, and the like are placed in the body.

In this example, as the supplied apparatuses, a monitor 31 that is a display device for displaying an image and a speaker 32 that is a sound output device for outputting sound are provided. Note that the speaker 32 may be omitted, and sound may be output from a speaker of the monitor 31.

Furthermore, an imaging device 24 that is, for example, a camera for imaging an inside of the body and a human sensor 25 that detects a user in the body are provided. Furthermore, a temperature sensor 26 that detects a temperature in the space 2 is provided in the body.

Furthermore, an information acquisition device 29 for acquiring individual information of a user of the space 2 may be provided on an outer surface of the body.

The information acquisition device 29 is, for example, a reader that reads an ID card held by a user.

Alternatively, the information acquisition device 29 may be a reader that reads a fingerprint, a pattern of veins, and the like of a user.

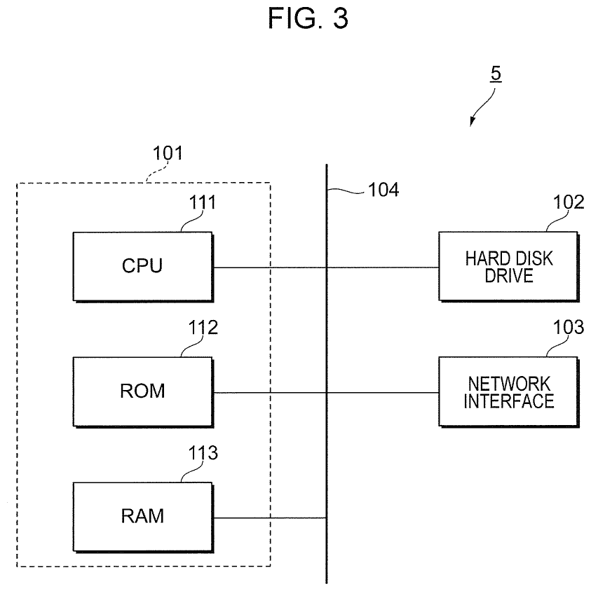

FIG. 3 is a view for explaining an example of a hardware configuration of the space management server 5.

The space management server 5 has a control unit 101 that controls operation of the whole server, a hard disk drive 102 in which data such as management data is stored, and a network interface 103 that achieves communication through a local area network (LAN) cable or the like.

The control unit 101 has a central processing unit (CPU) 111, a read only memory (ROM) 112 in which basic software, a basic input output system (BIOS), and the like are stored, and a random access memory (RAM) 113 used as a work area. The CPU 111 may be a multi-core CPU. The ROM 112 may be a rewritable non-volatile semiconductor memory. The control unit 101 is a computer.

The hard disk drive 102 is a device that writes and reads data into and from a non-volatile storage medium having a disc-shaped substrate coated with a magnetic substance. Note, however, that the non-volatile storage medium may be a semiconductor memory or a magnetic tape.

In addition, the space management server 5 includes an input device such as a keyboard or a mouse and a display device such as a liquid crystal display device as needed.

The control unit 101, the hard disk drive 102, and the network interface 103 are connected through a bus 104 or a signal line (not illustrated).

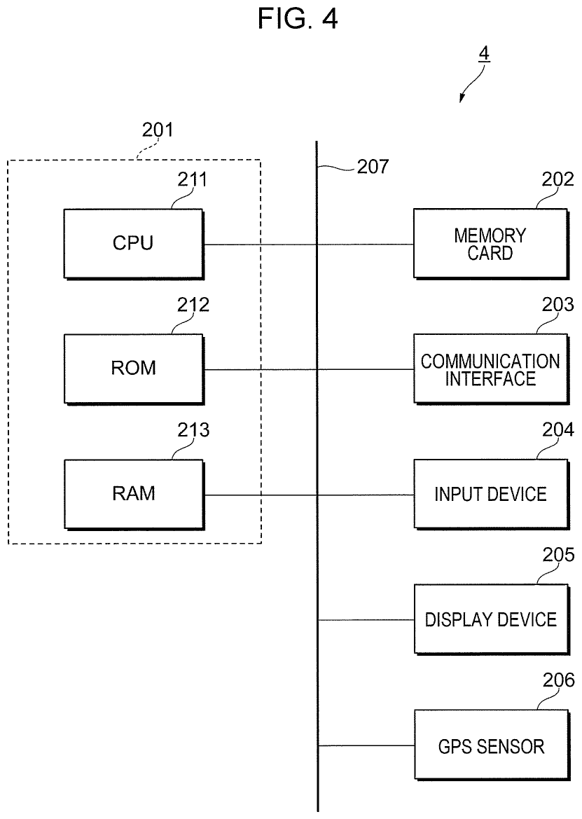

FIG. 4 is a diagram illustrating an example of a hardware configuration of the user terminal 4. FIG. 4 illustrates a case where the user terminal 4 is a smartphone.

The user terminal 4 has a control unit 201 that controls operation of the whole device, a memory card 202 in which various kinds of data are stored, various communication interfaces 203 that are compliant with a wireless communication standard, an input device 204 such as a touch sensor, a display device 205 such as a liquid crystal display device or an electro luminescence display device, and a global positioning system (GPS) sensor 206.

The control unit 201 has a CPU 211, a ROM 212 in which firmware, BIOS, and the like are stored, and a RAM 213 used as a work area. The CPU 211 may be a multi-core CPU. The ROM 212 may be a rewritable non-volatile semiconductor memory.

The communication interfaces 203 are, for example, an interface used for connection with a mobile communication system and an interface used for connection with a wireless LAN.

The GPS sensor 206 is a sensor that measures a position of the user terminal 4 on the basis of a radio wave received from a GPS satellite. Information on latitude, longitude, and altitude supplied from the GPS sensor 206 gives a current position of the user terminal 4. Note that the GPS sensor 206 may support an indoor position measurement system.

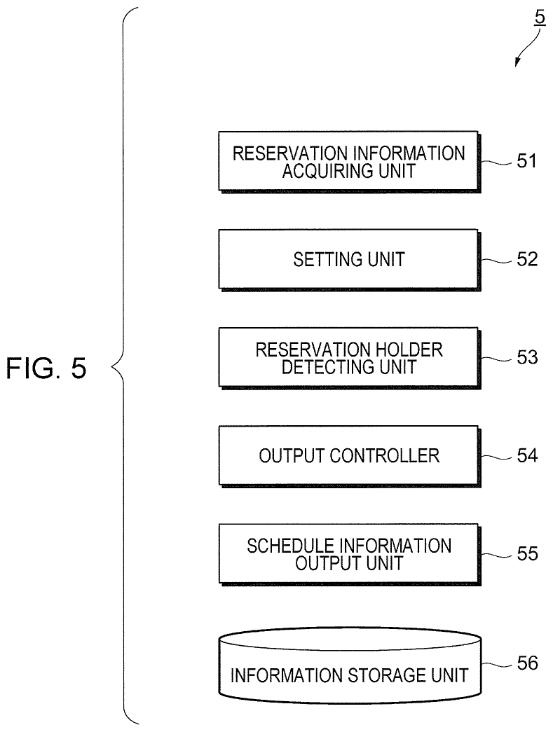

FIG. 5 is a view for explaining an example of a functional configuration of the space management server 5 (see FIG. 1). FIG. 5 illustrates a functional configuration concerning output of information in the space 2.

The space management server 5 includes a reservation information acquiring unit 51, a setting unit 52, a reservation holder detecting unit 53, an output controller 54, a schedule information output unit 55, and an information storage unit 56.

Although a case where these functional units are provided in the space management server 5, which is an example of an information processing apparatus, has been described in the present exemplary embodiment, plural information processing apparatuses may be prepared and these functional units may be separately provided in these information processing apparatuses. In this case, an information processing system is constituted by these information processing apparatuses, and the functional units are realized by this information processing system.

The reservation information acquiring unit 51, the setting unit 52, the reservation holder detecting unit 53, the output controller 54, and the schedule information output unit 55 are realized, for example, by execution of a program by the control unit 101 (see FIG. 3). The information storage unit 56 is realized, for example, by the hard disk drive 102.

The reservation information acquiring unit 51, which is an example of a reservation information acquiring unit, acquires reservation information that is information on a reservation of the space 2 made by a user (hereinafter, a user who made a reservation is referred to as a reservation holder).

The setting unit 52, which is an example of a setting unit, makes setting concerning output of information in the space 2 on the basis of the reservation information acquired by the reservation information acquiring unit 51.

The reservation holder detecting unit 53, which is an example of a detecting unit, detects arrival of a reservation holder who reserved a space 2 at the space 2. Furthermore, the reservation holder detecting unit 53 detects that a reservation holder who reserved a space 2 has exited the space 2.

The output controller 54, which is an example of an output controller, controls output of information in each of the spaces 2.

The schedule information output unit 55, which is an example of a schedule information output unit, outputs information on future schedule of a reservation holder who reserved a space 2.

The information storage unit 56 stores therein information concerning output of information in each of the spaces 2.

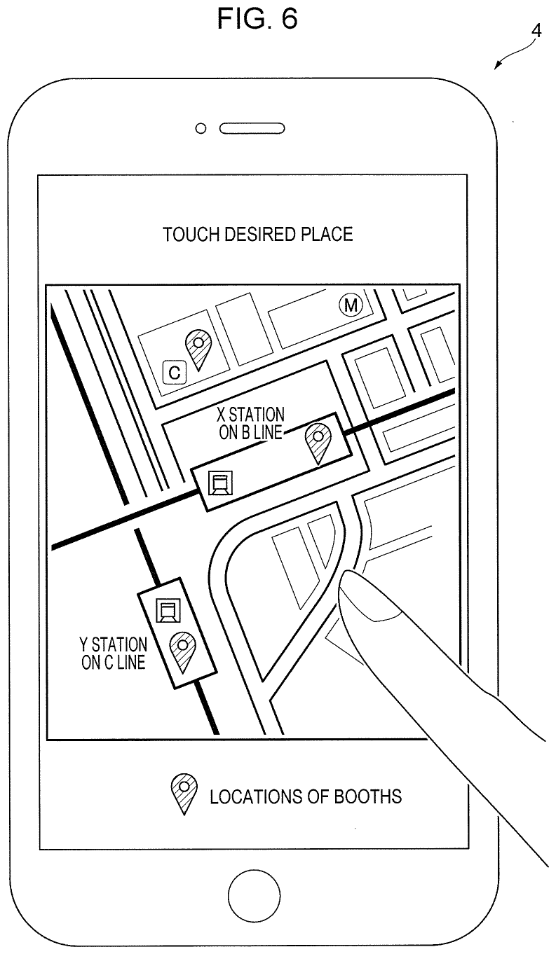

FIG. 6 illustrates an example of a display screen displayed on the user terminal 4 of a user (hereinafter referred to as a reservation applicant) who applies for a reservation when the reservation applicant tries to reserve the space 2.

On the display screen illustrated in FIG. 6, a map is displayed, and plural locations of the spaces 2, which are an example of places to be reserved by a reservation applicant, are displayed on the map.

In the present exemplary embodiment, when a reservation applicant tries to reserve a space 2, the reservation applicant first selects a location from among the plural locations of the spaces 2 on the map.

Note that the way in which the plural locations of the spaces 2 are displayed is not limited to this. For example, the plural locations of the spaces 2 may be displayed in a list form, and the reservation applicant may select a location from the list.

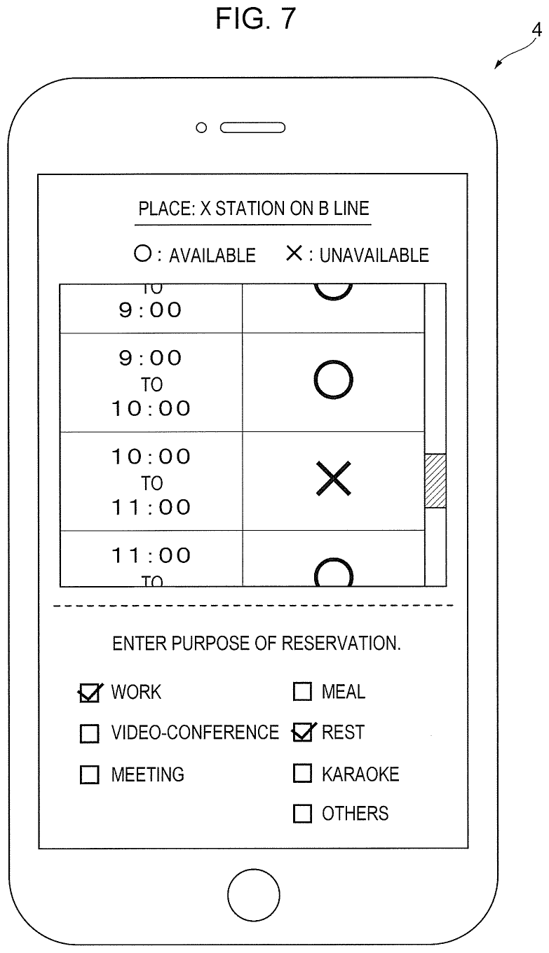

When the reservation applicant selects a location, room availability in each time zone at the selected location is displayed as illustrated in FIG. 7, which illustrates another example of a display screen displayed on the user terminal 4.

On the display screen illustrated in FIG. 7, an entry field for entry of a purpose of a reservation is displayed. In the present exemplary embodiment, plural candidates for a purpose of a reservation are displayed. The reservation applicant enters a purpose of the reservation by selecting a candidate from among the plural candidates.

The reservation applicant designates a reserved period of the space 2 and enters a purpose of the reservation on the display screen. Then, the reservation applicant presses a confirm button (not illustrated).

This causes the space management server 5 to confirm the reservation.

Specifically, the space management server 5 confirms the reservation as follows. The space management server 5 receives information on the location of the space 2 and the reserved period and information on the purpose of the reservation and registers the information on the location of the space 2, the reserved period, and the purpose of the reservation in the information storage unit 56.

Then, a confirmation result of the reservation is sent to the user terminal 4, and thus the reservation applicant is notified of the confirmation result of the reservation.

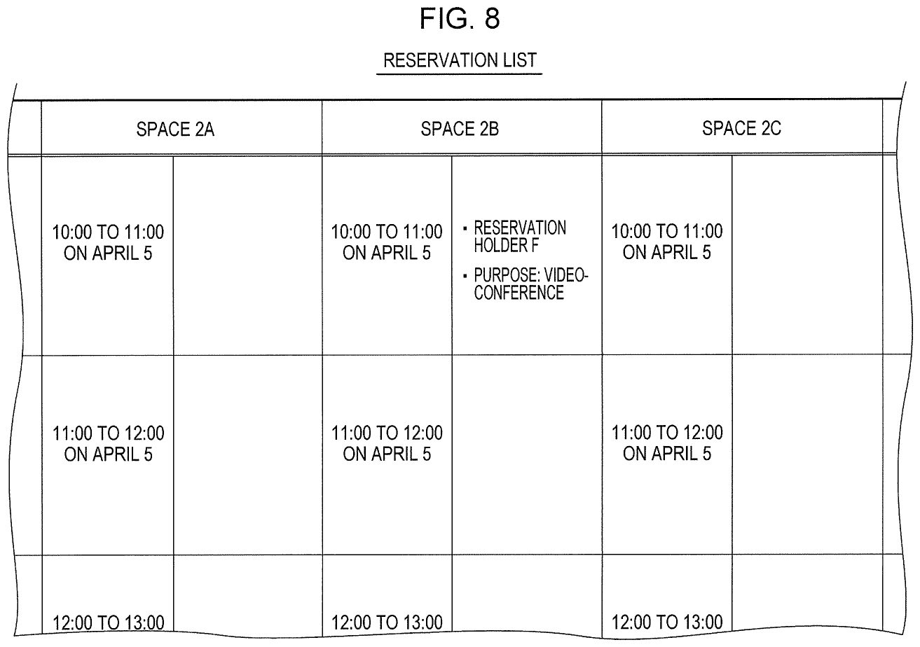

FIG. 8 illustrates a reservation list stored in the information storage unit 56 of the space management server 5.

In the present exemplary embodiment, when a reservation of a space 2 made by a user is confirmed, the user is added as a reservation holder to the reservation list as illustrated in FIG. 8. More specifically, a reservation holder who made a reservation and information on a purpose of the reservation are registered in a field corresponding to a space 2 and a time zone reserved by the reservation holder in the reservation list.

In this example, a reservation holder of a space 2B in a time zone 10:00 to 11:00 on April 5 is a reservation holder F, and a purpose of the reservation is a video-conference. The video-conference refers to a meeting with a third party at a different place over a communication line such as the Internet line.

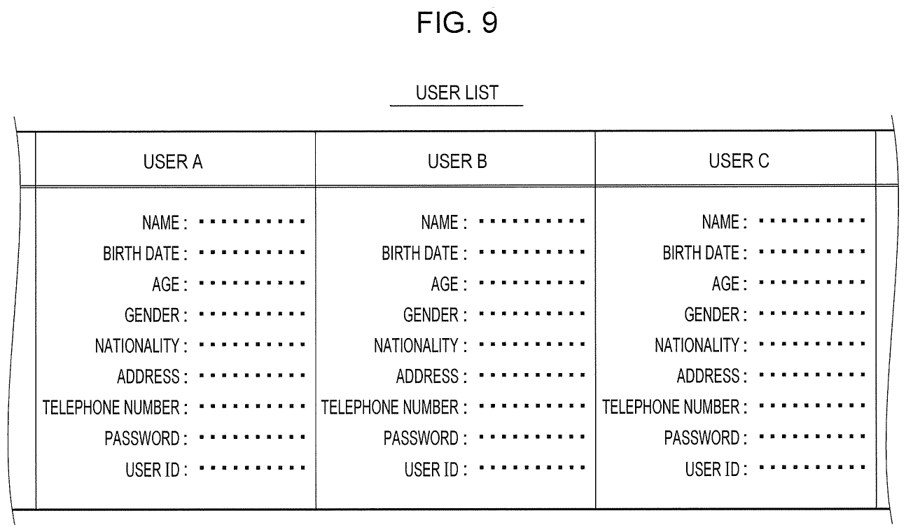

FIG. 9 illustrates a user list stored in the information storage unit 56 of the space management server 5.

In the present exemplary embodiment, users of the spaces 2 need to complete user registration in advance. In the present exemplary embodiment, the users who try to register themselves as users enter information such as their names, birth dates, ages, genders, nationalities, addresses, telephone numbers, and passwords, for example, on their user terminals 4.

In the present exemplary embodiment, these pieces of information are registered in the user list.

In the user list, information such as a name, a birth date, an age, a gender, a nationality, an address, and a telephone number is registered in association with each user, as illustrated in FIG. 9.

In the user list, passwords set by the users and user IDs allocated to the users are also registered in association with the respective users.

In the present exemplary embodiment, upon receipt of an instruction to unlock a space 2 from a user terminal 4, the space management server 5 compares a user who gave the instruction to unlock the space 2 with users registered in the reservation list (see FIG. 8), and, if the user who gave the instruction to unlock the space 2 is registered in the reservation list, unlocks the space 2.

More specifically, in the present exemplary embodiment, when a reservation holder tries to unlock a space 2, the reservation holder enters a user ID and a password on his or her user terminal 4. Through this authentication process, the operator who is operating the user terminal 4 is identified.

Then, in the present exemplary embodiment, when an instruction to unlock the space 2 is received from the user terminal 4 on which the operator has been authenticated, it is determined whether or not the operator who gave the instruction to unlock the space 2 is registered in the reservation list. In a case where the operator who gave the instruction to unlock the space 2 is registered in the reservation list, the space management server 5 unlocks the space 2.

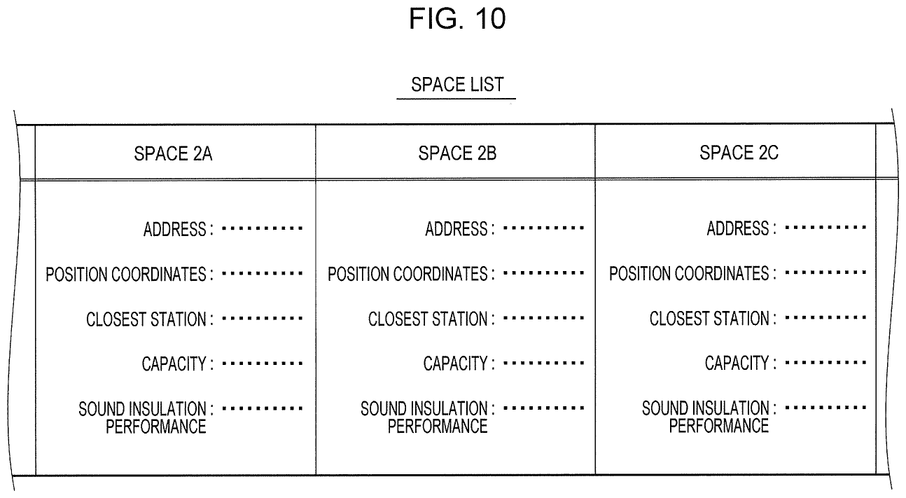

FIG. 10 illustrates a space list.

In the present exemplary embodiment, a space list is further stored in the information storage unit 56.

In the space list, information on a location such as an address and position coordinates and information on a closest station, a capacity, and sound insulation performance are registered for each of the spaces 2.

As the information on sound insulation performance, information indicative of a degree of sound insulation performance is registered, for example. Specifically, for example, any one of values 1 to 10 is registered.

In particular, in the present exemplary embodiment, a degree of sound insulation performance is rated on a 10-point scale, and any one of values 1 to 10 is registered as information indicative of a degree of sound insulation performance. In the present exemplary embodiment, a larger value indicates higher sound insulation performance, and a smaller value indicates lower sound insulation performance.

A booth-type space 2 has high sound insulation performance. Meanwhile, an open-type space 2 has low sound insulation performance.

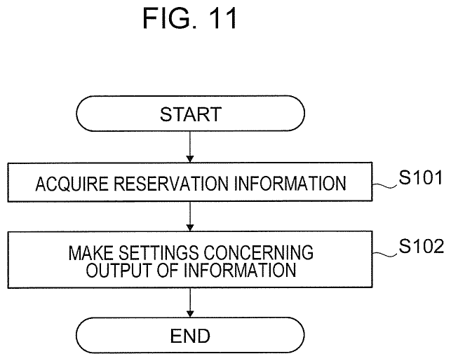

FIG. 11 illustrates an example of flow of processing performed by the space management server 5.

In the present exemplary embodiment, the space management server 5 makes settings concerning output of information in a space 2 (hereinafter referred to as a “reserved space 2”) reserved by a reservation holder before this space 2 is used by the reservation holder.

In particular, in the present exemplary embodiment, in which information is output through the monitor 31 and the speaker 32 placed in the space 2, the space management server 5 makes settings concerning output of the information in advance.

More specifically, in the present exemplary embodiment, advertisements and notifications are given to a user through the monitor 31 and the speaker 32, and the space management server 5 performs setting processing concerning output of such information.

Specifically, in the present exemplary embodiment, in this setting processing, first, the reservation information acquiring unit 51 acquires reservation information that is information on a reservation made for a space 2 by a reservation holder (step S101).

Specifically, the reservation information acquiring unit 51 acquires information such as a location of the reserved space 2, sound insulation performance of the reserved space 2, a scheduled time (a scheduled start time, a scheduled end time) of the reserved space 2, a reserved period of the reserved space 2, and the reservation holder of the reserved space 2 by referring to the reservation list, the user list, and the space list.

In the present exemplary embodiment, the reservation information acquiring unit 51 acquires information such as a name, an age, a gender, and a nationality as the information on the reservation holder.

Next, in the present exemplary embodiment, the setting unit 52 makes settings concerning output of information in the reserved space 2 on the basis of the reservation information acquired by the reservation information acquiring unit 51 (step S102).

In particular, in the present exemplary embodiment, information such as advertisements and guides of a surrounding area is output in each space 2, and the setting unit 52 makes settings concerning output of such information on the basis of reservation information.

Although the present exemplary embodiment discusses an example in which information is output through the monitor 31 and the speaker 32 placed in the body, information may be output toward an outside of the body through a monitor 31 and a speaker 32 placed outside the body.

Alternatively, information may be output toward both of an inside and an outside of the body through the monitor 31 and the speaker 32 placed in the body and the monitor 31 and the speaker 32 placed outside the body. Contents of information output toward the inside of the body and contents of information output toward the outside of the body may be different.

The setting unit 52 decides, for example, contents of information to be output in the reserved space 2 on the basis of the reservation information acquired by the reservation information acquiring unit 51. In particular, the setting unit 52 decides contents to be output in the reserved space 2 on the basis of the reservation information.

More specifically, the setting unit 52 decides contents of information to be output in the reserved space 2, for example, on the basis of attribute information of the reservation holder. More specifically, the setting unit 52 decides contents of information to be output in the reserved space 2, for example, on the basis of at least one of the age, gender, and nationality of the reservation holder.

Accordingly, in the present exemplary embodiment, contents of information to be output in the reserved space 2 vary, for example, depending on whether the reservation holder is a male or a female. For another example, contents of information to be output in the reserved space 2 vary depending on the age of the reservation holder. For still another example, contents of information to be output in the reserved space 2 vary depending on the nationality of the reservation holder.

Note that the setting unit 52 may decide contents of information to be output on the basis of one of the age, gender, and nationality, may decide contents of information to be output on the basis of two of the age, gender, and nationality, or may decide contents of information to be output on the basis of all of the age, gender, and nationality.

In a case where plural users use a space 2, the setting unit 52 may decide contents of information to be output in the reserved space 2 on the basis of attribute information of a specific user among these users.

For example, the setting unit 52 may decide contents of information to be output in the reserved space 2 on the basis of attribute information of a reservation holder who made a reservation of the reserved space 2 among the plural users.

Alternatively, the setting unit 52 may decide contents of information to be output in the reserved space 2 on the basis of attribute information of a user designated by the reservation holder among the plural users.

Alternatively, the setting unit 52 may make settings concerning output of information, for example, so that pieces of information corresponding to pieces of attribute information of the respective users are output sequentially.

The setting unit 52 may make settings concerning output of information so that information corresponding to attribute information of a specific user such as the reservation holder or the user designated by the reservation holder is output at a specific timing. More specifically, in this case, the setting unit 52 may make settings concerning output of information, for example, so that information corresponding to the attribute information of the specific user is output first.

Alternatively, the setting unit 52 may make settings concerning output of information, for example, on the basis of an attribute common to the plural users.

For example, in a case where all of the users are females, the setting unit 52 may decide contents of information to be output in the reserved space 2 on the basis of the attribute “female”.

Alternatively, for example, in a case where all of the users are over 60 years old, the setting unit 52 may decide contents of information to be output in the reserved space 2 on the basis of the attribute information “ages of over 60”.

In another aspect, there are cases where a reservation holder of the reserved space 2 and an actual user are different. In such cases, the setting unit 52 may make settings concerning output of information, for example, on the basis of attribute information of the actual user.

More specifically, the setting unit 52 may decide contents of information to be output in the reserved space 2 on the basis of attribute information of the actual user.

In the present exemplary embodiment, an authority to use (an authority to unlock) a space 2 that is originally given to a reservation holder can be given to another person. In a case where this usage authority is given to the other person, the reservation holder of the reserved space 2 and an actual user are different.

In this case, the setting unit 52 may decide contents of information to be output in the reserved space 2 on the basis of attribute information of this actual user. In particular, the setting unit 52 may decide contents of information to be output in the reserved space 2 on the basis of attribute information of a person different from the reservation holder.

In the present exemplary embodiment, to give a usage authority to another person, for example, a reservation holder of a reserved space 2 selects a new user to be given the usage authority by operating his or her user terminal 4. In the present exemplary embodiment, the selected new user is newly registered in the reservation list.

The setting unit 52 makes settings concerning output of information in the reserved space 2 on the basis of attribute information of the newly-registered user.

Furthermore, the setting unit 52 may make settings concerning output of information in the reserved space 2 on the basis of information on a purpose of the reservation acquired by the reservation information acquiring unit 51.

Specifically, for example, in a case where the purpose of the reservation is a predetermined specific purpose, the setting unit 52 makes settings for making a volume of sound that is output together with information lower than that in a case where the purpose of the reservation is not the specific purpose. In the present exemplary embodiment, “making a volume of sound lower” encompasses setting a volume of sound to zero.

More specifically, in a case where the purpose of the reservation is, for example, “video-conference” or “work”, the setting unit 52 makes settings for lowering a volume of sound that is output together with information. In particular, the setting unit 52 makes settings for lowering a volume of sound output from the speaker 32 placed in the space 2.

Meanwhile, in a case where the purpose of the reservation is, for example, “meal”, “karaoke”, or “rest”, the setting unit 52 makes settings for keeping a volume of sound that is output together with information. In particular, in this case, the setting unit 52 does not make settings for lowering a volume of sound.

The setting unit 52 may make settings concerning output of information on the basis of information on a reserved time of the reserved space 2 that is acquired by the reservation information acquiring unit 51.

More specifically, for example, the setting unit 52 may make settings concerning a volume of sound that is output together with information on the basis of the reserved time of the reserved space 2 that is acquired by the reservation information acquiring unit 51.

The reserved time may be a reserved start time or may be a reserved end time. The setting unit 52 makes settings concerning a volume of sound on the basis of the reserved start time or the reserved end time.

More specifically, for example, in a case where the reserved time of the reserved space 2 is a predetermined time, the setting unit 52 makes settings for making a volume of sound that is output together with information lower than that in a case where the reserved time of the reserved space 2 is not the predetermined time.

In particular, the setting unit 52 makes settings for lowering a volume of sound that is output from the speaker 32 placed in the reserved space 2.

More specifically, for example, in a case where the reserved time is early morning or the middle of the night, the setting unit 52 makes settings for making a volume of sound that is output together with information lower than that in a case where the reserved time is not early morning nor the middle of the night.

In other words, for example, in a case where the reserved time falls within a specific time zone, the setting unit 52 makes settings for making a volume of sound that is output together with information lower than that in a case where the reserved time does not fall within the specific time zone.

The setting unit 52 may make settings concerning output of information on the basis of information on a reserved period that is acquired by the reservation information acquiring unit 51. In particular, the setting unit 52 may make settings concerning output of information on the basis of an elapsed period from a reserved start time to a reserved end time.

More specifically, for example, in a case where a length of the reserved period is longer than a predetermined threshold value, the setting unit 52 make settings for making a period during which information is output in the reserved space 2 longer than that in a case where the length of the reserved period is not longer than the threshold value.

This is described below by using a specific example. For example, in a case where the reserved period acquired by the reservation information acquiring unit 51 is less than 30 minutes, the setting unit 52 sets a period during which information is output in the reserved space 2 to 1 minute.

Meanwhile, for example, in a case where the reserved period acquired by the reservation information acquiring unit 51 is equal to or longer than 30 minutes, the setting unit 52 sets a period during which information is output in the reserved space 2 to 2 minutes or longer.

Note that the information that is output in the reserved period in the reserved space 2 may be output all at once or may be output plural times in a divided manner.

In a case where the information is output plural times in a divided manner, if the period during which the information is output in the reserved space 2 is 1 minute as described above, a total period of output of the information is 1 minute. In a case where the information is output plural times in a divided manner, if the period during which the information is output in the reserved space 2 is 2 minutes as described above, a total period of output of the information is 2 minutes.

The setting unit 52 may make settings concerning output of information on the basis of information on a location of the reserved space 2 that is acquired by the reservation information acquiring unit 51.

More specifically, for example, the setting unit 52 may decide contents of information to be output in the reserved space 2 on the basis of an area to which the location of the reserved space 2 belongs.

In particular, in this case, correspondences between plural areas and contents of output information are stored in advance, for example, in the information storage unit 56.

The setting unit 52 specifies an area to which a reserved space 2 belongs on the basis of information on a location of the reserved space 2. In particular, the setting unit 52 specifies an area to which the reserved space 2 belongs from among the areas stored, for example, in the information storage unit 56 on the basis of an address and position coordinates of the reserved space 2.

Then, the setting unit 52 specifies contents of information associated with the specified area by referring, for example, to the information storage unit 56. The setting unit 52 sets the specified contents of information as contents of information to be output in the reserved space 2.

In this case, in the present exemplary embodiment, for example, contents of information output in a space 2 located in Tokyo and contents of information output in a space 2 located in a city other than Tokyo are different.

The setting unit 52 may make settings concerning output of information in a reserved space 2 on the basis of information on sound insulation performance of the reserved space 2 that is acquired by the reservation information acquiring unit 51.

More specifically, in this case, the setting unit 52 makes, for example, settings concerning a volume of sound that is output together with information on the basis of the information on sound insulation performance.

In the present exemplary embodiment, for example, any one of values 1 to 10 is registered in the space list as information indicative of a degree of sound insulation performance as described above. The setting unit 52 makes settings concerning a volume of sound on the basis of the value registered in the space list.

More specifically, the setting unit 52 makes settings for making a volume of sound high as for a space 2 having high sound insulation performance and makes settings for making a volume of sound low as for a space 2 having low sound insulation performance.

Although a case where any one of values 1 to 10 is registered as information indicative of a degree of sound insulation performance has been described above as an example, information on equipment of a space 2 such as the presence or absence of a wall or a ceiling, the presence or absence of a door, and the presence or absence of an opening or a gap may be registered in the space list as information on sound insulation performance.

The setting unit 52 may make settings concerning a volume of sound on the basis of the information on equipment.

As described above, in the present exemplary embodiment, the setting unit 52 makes settings concerning output of information in a reserved space 2 to be used by a reservation holder.

In the present exemplary embodiment, the output controller 54, which controls output of information in a reserved space 2, controls output of information in a reserved space 2 for which settings have been made by the setting unit 52 on the basis of contents of the settings made by the setting unit 52.

More specifically, for example, the output controller 54 controls output of information so that content decided by the setting unit 52 is output in the reserved space 2. In particular, the output controller 54 controls output of information so that information decided by the setting unit 52 is output in the reserved space 2.

More specifically, the output controller 54 controls output of information so that content decided by the setting unit 52 is read out from a storage device (not illustrated) and is then output in the reserved space 2.

The content that is output in the reserved space 2 is not limited to a moving image and may be a still image. Furthermore, sound may be output from the speaker 32 while a still image is being displayed on the monitor 31. Alternatively, the content that is output in the reserved space 2 may be sound only or an image only.

Furthermore, the output controller 54 controls output of content so that the content is output at a sound volume set by the setting unit 52 or the content is output during a period set by the setting unit 52.

The output controller 54 may output content at any timing within a reserved period of a reserved space 2.

The output controller 54 may start output of content in a reserved space 2, for example, when arrival of a reservation holder at the reserved space 2 is detected by the reservation holder detecting unit 53.

In particular, the output controller 54 may start output of information in a reserved place 2 when arrival of a reservation holder at the reserved space 2 is detected by the reservation holder detecting unit 53.

The reservation holder detecting unit 53 according to the present exemplary embodiment detects arrival of a reservation holder at a reserved space 2, for example, on the basis of output from the human sensor 25, the information acquisition device 29, the imaging device 24, the electronic lock 22C, and the opening closing sensor S1.

Specifically, the reservation holder detecting unit 53 determines that a reservation holder has arrived at a reserved space 2, for example, when the reservation holder is detected by the human sensor 25, when an ID card of the reservation holder is read by the information acquisition device 29, when the reservation holder is captured by the imaging device 24, when the electronic lock 22C is unlocked by the reservation holder, or when opening of the door 22 is detected by the opening closing sensor S1. Then, the reservation holder detecting unit 53 outputs a detection result indicating that the reservation holder has arrived at the reserved space 2.

In the present exemplary embodiment, upon output of the detection result indicating that the reservation holder has arrived at the reserved space 2, the output controller 54 starts output of information in the reserved space 2. In particular, upon output of the detection result indicating that the reservation holder has arrived at the reserved space 2, the output controller 54 starts output of information based on contents of settings made by the setting unit 52.

Accordingly, in this case, output of information starts in the reserved space 2 immediately after the arrival of the reservation holder at the reserved space 2.

In a case where information is output on the basis of detection of opening of the door 22, the output controller 54 may, for example, control output of information so that information is output when opening of the door 22 is detected first at or after a reserved start time but information is not output when opening of the door 22 is detected next and thereafter.

This makes it possible to avoid a situation where content is output every time the door 22 is opened. In particular, the reservation holder may often enter and exit the reserved space 2, for example, to go to a restroom. According to the present exemplary embodiment, it is possible to avoid a situation where content is output every time the reservation holder enters or exits the reserved space 2.

The output controller 54 may stop output of information in a case where the information is being output when the reservation holder exits the reserved space 2.

In particular, the output controller 54 may stop output of information in a case where the information is being output, for example, when the reservation holder exits the reserved space 2 to take a rest or leave the reserved space 2 early.

Note that whether or not the reservation holder has exited the reserved space 2 is detected by the reservation holder detecting unit 53.

The reservation holder detecting unit 53 determines that the reservation holder has exited the reserved space 2, for example, in a case where the reservation holder is no longer detected by the human sensor 25, when an ID card of the reservation holder (who tries to exit the reserved space 2) is read by the information acquisition device 29, in a case where the reservation holder is no longer detected in an image taken by the imaging device 24, when the electronic lock 22C is locked, or when closing of the door 22 is detected by the opening closing sensor S1. Then, the reservation holder detecting unit 53 outputs a detection result indicating that the reservation holder has exited the reserved space 2.

In the present exemplary embodiment, upon output of this detection result, the output controller 54 stops output of content.

In the present exemplary embodiment, a personal computer (PC) brought by a user is connectable to the monitor 31. By connecting the PC to the monitor 31, the user can cause a screen for his or her work to be displayed on the monitor 31. In this way, the user can do his or her work while seeing a screen larger than a screen of the PC.

In this case, the user cannot temporarily see the screen for work while content is being output on the monitor 31, but when output of the content is finished, the user can see the screen for work again.

In the present exemplary embodiment, the reservation holder can make settings so that information is not output in the reserved space 2. In particular, in the present exemplary embodiment, the reservation holder can make settings so that content is not output in the space 2.

More specifically, in this case, the reservation holder can make settings, for example, on the monitor 31 so that information is not output. In particular, in a case where the monitor 31 is a touch panel, the reservation holder can make settings on the monitor 31 so that information is not output.

Alternatively, it is possible to employ a configuration in which the reservation holder can make settings on the user terminal 4 so that information is not output.

In a case where the reservation holder makes settings so that information is not output, the output controller 54 does not output information in the reserved space 2.

In a case where the reservation holder makes settings so that information is not output, the reservation holder may be charged a fee. Since no advertisement is given in a case where information is not output, it is assumed that an advertising revenue which an administrator is supposed to get decreases. By charging the reservation holder a fee, the administrator can get a revenue that replaces the advertising revenue.

Furthermore, in the present exemplary embodiment, when a reservation holder arrives at a reserved space 2, the schedule information output unit 55 outputs information on future schedule of this reservation holder.

Specifically, in the present exemplary embodiment, the schedule information output unit 55 acquires schedule information of a reservation holder who has arrived at a reserved space 2 from a calendar (an electronic calendar in which date information and schedule information are registered in association with each other) stored in the information storage unit 56 or from a calendar stored in another server. Then, the schedule information output unit 55 outputs the schedule information to the reserved space 2.

In the present exemplary embodiment, this schedule information is displayed on the monitor 31. This allows the reservation holder to grasp information on his or her future schedule. In other words, the reservation holder can grasp his or her future schedule.

The schedule information output unit 55 may output route information as the information on future schedule of the reservation holder.

The schedule information output unit 55 acquires information on a next destination of the reservation holder from the calendar and acquires route information from the reserved space 2 to this next destination. Then, the schedule information output unit 55 outputs this route information to the reserved space 2. This causes the route information to be displayed on the monitor 31 of the reserved space 2.

Note that an order in which the content and the schedule information or the route information are output is not limited in particular. As described above, the content may be output immediately after arrival of the reservation holder at the reserved space 2, and then the schedule information or the route information may be output.

Alternatively, the schedule information or the route information may be output immediately before the reserved end time of the reserved space 2. In other words, the schedule information or the route information may be output immediately before the reservation holder leaves for the next destination.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a reservation information acquiring unit that acquires reservation information that is information on a reservation of a place made by a user; and
a setting unit that makes settings concerning output of information in the place reserved by the user on a basis of the reservation information.

2. The information processing system according to claim 1, wherein
the reservation information acquiring unit acquires information on the user as the reservation information; and
the setting unit makes settings concerning the output on a basis of the information on the user.

3. The information processing system according to claim 2, wherein
the reservation information acquiring unit acquires information on at least one of an age, a gender, and a nationality of the user as the information on the user; and
the setting unit decides contents of the information to be output in the place on a basis of the information on the at least one of the age, the gender, and the nationality of the user.

4. The information processing system according to claim 1, wherein
the reservation information acquiring unit acquires information on a purpose of the reservation of the user as the reservation information; and
the setting unit makes settings concerning the output on a basis of the information on the purpose of the reservation.

5. The information processing system according to claim 4, wherein
in a case where the purpose of the reservation is a predetermined specific purpose, the setting unit makes a volume of sound that is output together with the information lower than that in a case where the purpose of the reservation is not the specific purpose.

6. The information processing system according to claim 1, wherein
the reservation information acquiring unit acquires information on a reserved time of the place as the reservation information; and
the setting unit makes settings concerning the output on a basis of the information on the reserved time.

7. The information processing system according to claim 6, wherein
the setting unit makes settings concerning output of a volume of sound that is output together with the information on a basis of the information on the reserved time.

8. The information processing system according to claim 7, wherein
in a case where a time specified by the information on the reserved time is a predetermined time, the setting unit makes the volume of the sound that is output together with the information lower than that in a case where the time specified by the information on the reserved time is not the predetermined time.

9. The information processing system according to claim 1, wherein
the reservation information acquiring unit acquires information on a reserved period of the place as the reservation information; and
the setting unit makes settings concerning the output on a basis of the information on the reserved period.

10. The information processing system according to claim 9, wherein
in a case where a length of the reserved period is longer than a predetermined threshold value, the setting unit makes a period during which the information is output in the place longer than that in a case where the length of the reserved period is not longer than the predetermined threshold value.

11. The information processing system according to claim 1, wherein
the reservation information acquiring unit acquires information on the place as the reservation information; and
the setting unit makes settings concerning the output on a basis of the information on the place.

12. The information processing system according to claim 11, wherein
the setting unit decides contents of the information to be output in the place on a basis of an area to which a place specified by the information on the place belongs.

13. The information processing system according to claim 1, wherein
the reservation information acquiring unit acquires information on sound insulation performance of the place as the reservation information; and
the setting unit makes settings concerning the output on a basis of the information on the sound insulation performance.

14. The information processing system according to claim 13, wherein
the setting unit makes settings concerning a volume of sound that is output together with the information on a basis of the information on the sound insulation performance.

15. The information processing system according to claim 1, further comprising:
a detecting unit that detects arrival of the user at the place; and
an output controller that controls output of information in the place,
wherein the output controller controls output of the information in the place on a basis of the settings made by the setting unit, and the output controller starts output of the information when arrival of the user at the place is detected by the detecting unit.

16. The information processing system according to claim 1, further comprising a schedule information output unit that outputs information on future schedule of the user upon arrival of the user at the place.

17. An information processing apparatus comprising:
a reservation information acquiring unit that acquires reservation information that is information on a reservation of a place made by a user; and
a setting unit that makes settings concerning output of information in the place reserved by the user on a basis of the reservation information.

18. A non-transitory computer readable medium storing a program causing a computer to execute a process for information processing, the process comprising:
acquiring reservation information that is information on a reservation of a place made by a user; and
making settings concerning output of information in the place reserved by the user on a basis of the reservation information.
